(19) United States
(12) Patent Application Publication
(10) Pub. No.: US 2020/0179217 A1
(43) Pub. Date: Jun. 11, 2020

(54) A WEARABLE DEVICE FOR PREVENTING THE FALL OF A USER

(71) Applicant: SCUOLA SUPERIORE DI STUDI UNIVERSITARI E DI PERFEZIONAMENTO SANT'ANNA, Pisa (IT)

(72) Inventors: Federica APRIGLIANO, San Giuliano Terme (Pisa) (IT); Dario MARTELLI, Pisa (IT); Silvestro MICERA, Firenze (IT); Vito MONACO, Lucca (IT); Andrea PARRI, Campiglia Marittima (Livorno) (IT); Peppino TROPEA, Pisa (IT); Nicola VITIELLO, Pontedera (Pisa) (IT)

(73) Assignee: SCUOLA SUPERIORE DI STUDI UNIVERSITARI E DI PERFEZIONAMENTO SANT'ANNA, Pisa (IT)

(21) Appl. No.: 16/609,088

(22) PCT Filed: May 9, 2018
(86) PCT No.: PCT/IB2018/053217

§ 371 Date: Oct. 28, 2019

(30) Foreign Application Priority Data
May 10, 2017 (IT) 102017000050753

(51) Int. Cl. A61H 3/00

(52) U.S. Cl. CPC A61H 3/00; A61H 2003/007; A61H 2201/1628; A61H 2201/164; A61H 2205/088; A61H 2201/5061; A61H 2201/5069; A61H 2201/5084; A61H 2230/625; A61H 2201/165

(57) ABSTRACT

The present invention refers to the field of wearable robotic devices, and in particular it concerns a wearable robotic device adapted to be connected with the lower limbs of a user subject, to detect a potentially dangerous balance loss, probably causing a fall, and consequently activate appropriate strategies to sustain the same user and recover the balance, avoiding the fall to the ground.

### FIELD OF THE INVENTION

The present invention refers to the field of wearable robotic devices, and in particular it concerns a wearable robotic device adapted to detect a balance loss in a user subject and consequently activate appropriate strategies to sustain the same user and recover the balance, avoiding a fall to the ground.

### BACKGROUND OF THE INVENTION

The act of falling can be considered as an unexpected motor task, the evolution of which does not depend exclusively from the characteristics of the active user. In fact, environmental factors such as slippery or bumpy floors or potentially dangerous conditions in the working environment, and personal factors linked with behaviors capable to alter the psychophysical state such as alcohol or drug abuse, neurologic, muscular and skeletal pathologies or more simply aging, all these factors increase the likelihood of a fall of the subject. In vulnerable users, such as the elderly, the lower limb(s) amputees, or patients struck by hemiparesis, falls represent one of the main causes of disability, hospitalization and even death of such subjects, and consequently also a serious economic problem for public healthcare and welfare. It is therefore strongly needed the pursuit of solutions that prevent a subject from falling, not only to improve his/her life quality, but also to control the costs for the collectivity.

Despite such urgent need, however, effective and acceptable solution to prevent the possible consequences of a fall have not been devised; the pursuit for them remains therefore a technological challenge with no satisfactory result.

The more technologically mature solution is presently the one according to which clothes are equipped with airbags, so as to mitigate the possible impact of the user with the ground. For example, a waist belt has been proposed, equipped with motion sensors that, when detecting certain movements and accelerations of the user wearing the belt, activate the ejection of micro-airbags from the belt. These airbags wrap around the part of the body about and over the hips, creating a protection for this body part (a particularly vulnerable and injury-prone part especially in the elderlies) before it may strike the ground. However, this approach merely brings about a passive protection that, although it may mitigate the effects of an impact with the ground, has no effectiveness in preventing the fall. Moreover, during the daily activities of the possible users, typically people with a high likelihood of incurring falls (due to intrinsic and/or extrinsic factors), in particular elderly or disabled users, false alarms in the airbag activation may easily occur, and these occurrences, especially if of the false positive type, tend to dissuade the users from taking advantages of these devices. In fact, in case of malfunctioning, the airbags are ejected when unneeded, highlighting the vulnerable and troublesome condition of the user and causing a condition of psychophysical stress and discomfort.

New approaches are also under evaluation for controlling prosthesis for transfemoral amputees with the aim of reducing the risk of falls (see e.g. Thatte, N. et al. IEEE Trans Biomed Eng 63, 904-913, (2015) e Highsmith, M. J. et al. Prosthet Orthot Int 34, 362-377, (2010)). These solutions, however, cannot be successfully transferred to all vulnerable users and subjects that are likely to incur falls, that still own their lower limbs with a certain degree of functionality.

Generally speaking, the so-called full body robotic exoskeletons (such as e.g. those disclosed in publications US2003/120183 or US2010/094188), useful for assisting the gait of a great number of subjects, in spite of developing some auxiliary functions that at least indirectly fight balance losses, are not designed in a specific and high-performing way to effectively assist the user in cases of a fall risk. Moreover, one of the main problems in the use of a great part of known exoskeletons is the defective possibility of an interaction between the apparatus and the user wearing the same, and this is a negative aspect which is particularly annoying when the user is still in possession of significant voluntary capabilities. When such a user loses his/her balance and runs the risk to fall to the ground, he/she is often capable to produce a certain reaction against the fall, although feeble and not quick enough to actually prevent the same fall in most cases. For this reason, an excessive reaction yielded by an apparatus sustaining the user, could be in that case a bother; more helpfully, an exoskeleton device should assist the user in a “ecological” and symbiotic way, providing assistance only if necessary in case of an actual risk of falling, and in that case providing only the energy and support that are indeed lacking for the user to recover balance and avoid falling.

The need is thus felt for an effective and ecological technological solution, that combines the capability to identify—in a user—a balance loss such that a fall may ensue, with a proactive action that can sustain and cooperate the subject during the balance recovery, actually preventing the fall, with a tuned assistance on the basis of the voluntary capabilities of the user subject.

### SUMMARY OF THE INVENTION

The present invention has then the object of solving such a technical problem, by providing a wearable device capable to identify an unexpected and potentially risky posture change thanks to a sensor system, and also to actively assist, thanks to appropriate actuators, the balance recovery at a phase of incipient fall, that is in the time that runs from the balance loss to the impact with the ground.

It is therefore an object of the present invention to provide a wearable device that permits to timely identify a balance loss condition in the subject wearing the device, and also to switch an active support on, preventing the fall of the user and helping him to find his/her balance back.

A particular object of the present invention is to provide a wearable device of the above-mentioned type that attains modular characteristics, both in connection with hardware aspects—by allowing to vary the number and types of sensors and actuators—and in connection with software aspect, by permitting the reconfiguration of the control and acquisition system of the sensor depending on the actual needs of the user subject.

A further particular object of the present invention is to provide a wearable device of the above-mentioned type that is completely flexible in terms of the possible environments of use, so that it can find applicability in the most diverse contexts, both outdoor and indoor (e.g. houses, hospitals, workplaces etc.).

An even further particular object of the present invention is to provide a wearable device that, thanks to suitably sized energy storage and release means, is capable to customize the assisting response to the subject user on the basis of his/her needs and specific anthropometric features.

These and other objects are attained with the wearable device according to the invention, the essential features of which are defined by the attached independent claim; further important features are defined by the dependent claims.

### BRIEF DESCRIPTION OF THE DRAWINGS

The features and advantages of the device according to the present invention will become apparent from the following description of embodiments thereof, provided with exemplifying and non-limiting purposes, with reference to the attached drawings wherein:

FIGS. 1a), b) e c) respectively show front and rear perspective views, and a side view, of a preferred embodiment of the wearable device according to the invention;

FIG. 2 shows a block diagram representing the interactions among the main components of the device of the previous figures.

### DETAILED DESCRIPTION OF THE INVENTION

The technological solution proposed by the present wearable device, to be worn in contact with the hips and lower limbs of a subject, permits to timely detect a balance loss in the same subject and to consequently activate appropriate strategies to support the user during the balance recovery phase, actually preventing a fall, but remaining completely transparent in all the situations in which no assistance is sought from the device.

With the term “subject” or “user subject” it is here particularly intended a person that runs a high risk of falling due to intrinsic factors (aging or neurologic, muscular and skeletal pathologies) or extrinsic ones (environments that are contaminated by substances of presence of fittings that reduce the friction coefficient between the user and the ground, or environments with bumpy or unstable floor).

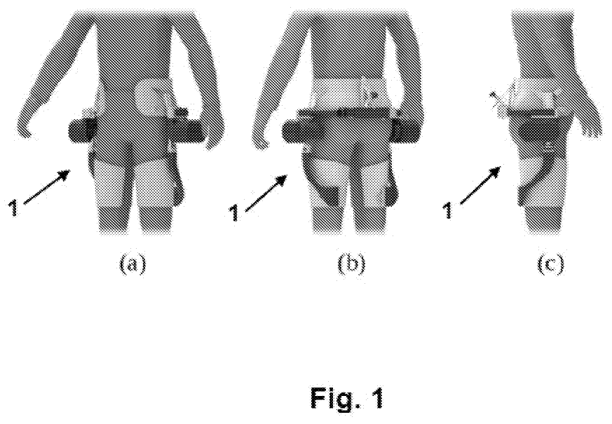

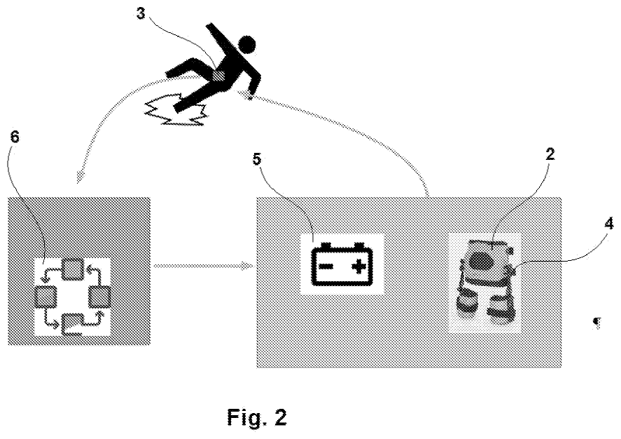

With reference to the attached FIGS. 1 and 2, the wearable device 1 according to the present invention comprises a pelvis orthosis 2 having at least one flexion/extension degree of freedom, to be worn by a user subject, in which such orthosis comprises:

sensor means 3 adapted to collect information related to the user's motion;

actuator means 4 adapted to cooperate with the user;

means 5 for storing and releasing energy; and

a control unit 6 adapted to process the information coming from the sensor means 3 with the aim of revealing possible balance loss conditions and incipient fall of the user, to activate the energy storage and release means 5 so that an appropriate amount of energy is released to the actuator means 4 for balance recovery, in which the energy amount possibly released, and used by the actuator means 4 to drive the hip flexion/extension 6 is selected on the basis of the information coming from the sensor means 3 and is commensurate with the user's needs.

The pelvis orthosis 2 of the present device has at least one degree of freedom of flexion/extension in correspondence with each hip joint, and preferably it has three degrees of freedom, namely hip flexion/extension, hip intra-extra rotation and hip abduction/adduction, so that the user subject can freely move the hips according to the physiological movements.

The control unit 6 in the present device comprises at least one processor that in real time at least analyses the data coming from the sensor means 3 and, based on a decisional algorithm based on adaptive oscillators, activates the assistive strategies appropriate to the circumstances, in particular directed to balance recovery of the user that is going to fall to the ground. Said control unit 6 is adapted to compare in real time the difference between the angles of the hip joint measured in the user and corresponding reference value estimated through the adaptive oscillators, detecting a balance loss when the difference between the measured value and the estimated reference value exceeds a predetermined threshold. In particular, the average and standard deviation of the difference between the two values are calculated in a movable time window of m samples. The so calculated average and standard deviation of the samples dynamically describe, through a linear combination thereof, the threshold t that when exceeded reveals an unexpected postural change. When the difference between the angle measured at the joint and the estimated angle exceeds the threshold t for a predetermined number of consecutive samples, the algorithm provides as an output the identification of the imminent balance loss.

Thanks to such a control unit 6 the response of the device can be tuned as desired on the basis of the anthropometric features of the subject, of his/her psychophysical or pathological condition, of the environmental circumstances, and of the type of fall the user is incurring.

Contrary to the similar known devices, the device of the invention has therefore an active behavior in promoting the balance recovery in case of incipient fall; moreover, if needed and based on the motor capabilities of the user subject, the device can be configured to assist the locomotion during voluntary motor tasks; on the other hand, the device can remain “transparent” in any other circumstances, letting the subject freely move, also thanks to the minimum bulk and lightness that characterize the device. Besides to this, also in case of active assistance to regain balance, the present device is capable to tune the extent of the force released through the actuators, and then the strength of the support provided to the user, depending on the needs and condition of the same user subject.

The technological solution realized by the present device thus combines a sensor system capable to identify in real time an emergency situation corresponding to the balance loss by detecting variables coming from the user subject, with a strategy that assists balance recovery. More specifically, the sensor system measures in real time variables/parameters coming from the subject and provides consequent inputs to the control unit; the control unit 6 integrates the information taken from the sensor means 4 so as to:

recognize situations of balance loss and then incipient fall,

select an adequate amount of energy to be supplied through the energy storage and release means 5, and

quickly activate the actuator means 4 designed for balance recovery;

whereby the actuation means cooperate with the user subject with the aim to regain balance.

According to a particular embodiment of the invention the wearable device 1 can further comprise a lower limb orthotic module with one or more joints of the lower limbs, monolaterally or bilaterally, mechanically connected to the pelvis orthosis 2.

According to the invention, the sensor means 3 consist of a system of wearable sensors suitable for detecting physiological, biomechanical and kinematic variables that represent early indicators of an incipient fall; to such purpose, suitable sensors are e.g. inertial sensors such as accelerometers, gyroscopes and magnetometers, movement sensors, sensorized insoles, devices for obtaining electromyographic signals, and sensors for monitoring the angular excursions of the articular joints.

In general terms, the sensor means 3 can comprise sensor to detect one or more among the following aspects: the linear and/or angular position of part/s of the wearable device 1 and/or of the user; forces and/or pressure and/or torques at part/s of the device 1, at the ground and/or between the user and the device 1; speed and/or acceleration of part/s of the device 1 and/or of the user.

Preferably, the sensor means are distributed on the wearable device 1 and comprise wireless sensors.

The energy storage and release means 5 can be reduced to practice according to the invention through devices capable of storing electric energy (for instance a battery) and/or mechanic energy (such as springs), or pneumatic energy to the purpose of adequately feeding the actuator means that interfaces the user via the pelvis orthosis, and of interfering with the dynamics of the incipient fall to promote the balance recovery.

Preferably, the actuator means 4 onboard the pelvis orthosis in the device according to the invention are actuators that drive the joints possibly both in the form of “passive” drives (for instance viscoelastic elements) and in the form of “active” drives (for instance electromagnetic hydraulic or pneumatic actuators) and are finalized to the quick release of energy by applying to the articular joint a torque that opposes the balance loss, to assist the postural recovery of the user subject and prevent the fall to the ground.

According to a preferred embodiment of the invention, in case of a detection of a perturbation with balance loss and likelihood of a fall, the control unit 6 of the present device activates the energy release to the actuator means 4 to apply couple of synchronous forces of extension and flexion respectively to the hip joint corresponding to the perturbated lower limb and to the hip joint corresponding to the non-perturbated limb. This counteraction activated by the device of the invention, as shown by a series of experimental tests, has proven itself mostly effective to modify the stiffness of the subject and increase the interaction force between the foot and the ground, and also to widen the support basis and assist the standing of the subject on both feet, improving his/her stability. In a particularly preferred embodiment the present device via the control unit 6 is capable of adjusting the extent of the torque applied proportionally to the overall weight of the subject including also the device worn and the duration of the application. The most effective results were detected experimentally for a torque of about 0.2 Nm per Kg of weight of the user subject plus the device, applied for a time of 0.25 sec starting from the detection of a perturbation of the lower limbs with balance loss and likelihood of fall.

The wearable device of the present invention, contrary to the known devices, combines a system that identifies a balance loss of the user subject, potentially dangerous and bringing to a fall, to a system actively assisting the subject, for helping him/her to regain balance and avoid the fall. More particularly, thanks to the above described device arrangement, it is capable to respond immediately to a balance loss, by driving the flexion/extension of the hip and then change the response of the lower limb articular joints of the subject, promoting his/her adequate standing on two feet and increasing the friction force between the lower limbs and the ground.

A further advantage of the present wearable device is its modularity thanks to a modular mechatronic system that can be easily reconfigured to swiftly respond to the specific need of each category of user. The present device is modular both as far as the hardware is concerned, being it possible to vary the number and type of sensors and of actuators, and far as the software is concerned, that is in the control and acquisition system of the sensors that can be reconfigured and customized depending on the user's needs.

Advantageously, moreover, the wearable device of the invention can be equipped with energy storage means and/or release means suitably sized so as to customize the assistive response of the device (torque/power) based on the needs and anthropometric features of the user subject.

A further advantage is also the flexibility of the wearable device according to the invention, which can be likewise effectively applicable in all the scenarios that present a fall risk, both structured and unstructured ones, and in any kind of environment, both indoors e.g. in houses, hospitals or workplaces, and outdoors.

The present invention has been described so far with reference to a preferred embodiment. It is intended that there may be other embodiments which refer to the same inventive concept, falling within the scope of the appended claims.

1. A robotic wearable device, comprising an orthotic pelvis module adapted to be worn by a user in correspondence with the pelvis and having at least a flexion/extension degree of freedom at each hip joint of the same user, said module comprising:
sensor means, adapted to detect parameters related to said user's motion including a measurement of at least one motion parameter of each hip joint;
actuator means, adapted to cooperate with said user for actuating or assisting a flexion/extension movement of one or of both said hip joints;
means for storing and releasing energy, adapted to activate said actuator means; and
a control unit comprising at least one processor configured to elaborate in real time said parameters coming from said sensor means;
said device wherein said processor of said control unit is also configured to:
detect possible perturbations at the lower limbs that are cause of balance loss and risk of imminent fall in said user, and
accordingly activate, by means of an algorithm based on adaptive oscillators, said means for storing and releasing energy for a possible release of a certain amount of energy to said actuator means said amount being commensurate with environmental needs and said user's personal needs in order to recover balance, avoiding fall, by actuating or assisting the flexion/extension of one or both hip joints.

2. The wearable device according to claim 1, wherein based on said algorithm, said processor is configured to compare in real time at least said measure of said motion parameter and a corresponding reference value estimated through said adaptive oscillators, said perturbations being detected when the difference between said measured value and said estimated reference value exceeds a predetermined threshold.

3. The wearable device according to claim 2, wherein the average and standard deviation of the difference between the two values are calculated in a movable time window of m samples, the so calculated average and standard deviation of the samples dynamically describing, through a linear combination thereof, said threshold, said perturbations being detected when the difference between said measured value and said estimated reference value exceeds said threshold for a predetermined number of consecutive samples.

4. The wearable device according to claim 1, wherein said control unit is configured to activate the release of energy to actuator means for the application of synchronous torques of extension and flexion respectively at the hip portion corresponding to a perturbated lower limb and at the hip portion corresponding to a non-perturbated lower limb.

5. The wearable device according to claim 4, wherein said control unit is configured to adjust the amount of said applied torques so that it is proportional to the total weight of said user wearing the device and to further adjust the duration of the application of said torques starting from the detection of a perturbation at lower limbs with balance loss and risk of fall.

6. The wearable device according to claim 1, wherein said orthotic pelvis module has three degrees of freedom for each hip portion, in particular of hip flexion/extension, hip intra-extra rotation and hip abduction/adduction.

7. The wearable device according to claim 1, further comprising a lower limb orthotic module with one or more joints of the lower limbs, monolaterally or bilaterally, mechanically connected to the orthotic pelvis module.

8. The wearable device according to claim 1, wherein said sensors are adapted to monitor one or more of the following parameters: the linear and/or angular position of part/s of the wearable device and/or of the user; forces and/or pressure and/or torques at part/s of the device, at the ground and/or between the user and the device (1); speed and/or acceleration of part/s of the device and/or of the user.

9. The wearable device according to claim 1, wherein said means for storing and releasing energy consist of devices able to store electric and/or mechanical energy and of suitably supplying said actuator means connected to the user by means of said orthotic pelvis module.

10. The wearable device according to claim 1, wherein said actuator means consist of devices for the actuation of joints selected from the group consisting of viscoelastic elements, electromagnetic actuators, hydraulic actuators and pneumatic actuators.
